(19) United States
(12) Patent Application Publication
(10) Pub. No.: US 2011/0224970 A1
(43) Pub. Date: Sep. 15, 2011

(54) METHOD AND SYSTEM FOR PROVIDING TRANSLATION SERVICES

(76) Inventor: Andrzej Bernal, Koszalin (PL)

(21) Appl. No.: 13/128,239

(22) PCT Filed: Oct. 24, 2009
(86) PCT No.: PCT/IB2009/054706

§ 371 Date: May 8, 2011

Related U.S. Application Data
(63) Continuation of application No. 12/269,067, filed on Nov. 12, 2008.
Application No. 12/269,067 is a continuation of application No. 12/545,109, filed on Aug. 21, 2009, now abandoned.

(51) Int. Cl. G06F 17/28

(52) U.S. Cl. 704/8

(57) ABSTRACT

A method and system of automatic interpreting in which either one or two telecommunication devices are used. In one arrangement, there is one phone shared by two parties who speak different languages. The languages to be spoken are identified e.g. using an onscreen menu on the phone and an appropriate interpreter is selected from a database and a call is placed to him so that he can interpret between the two parties at the other end of the line. In a second arrangement the two persons and the interpreter are at separate locations and a three-way call is initiated after the appropriate interpreter has been selected from the database.

### BACKGROUND OF DISCLOSURE

1. Field of the Disclosure

Embodiments disclosed herein generally relate to a method and system for providing translation services to parties in need thereof, and more particularly to providing translation services over a telecommunication network.

2. Background

Businesses and private parties avail themselves to receiving telecommunication from others. A typical business or household has a plurality of telephones, fax machines, and computers with the help of which it receives communication. Some of the communication is left for the business to process after it is received (e.g., voice mail, faxes, emails); other communication is customarily dealt with in real time while it is being received (e.g., telephone calls, computer chats).

The advent of global reduction of telecommunication prices and increased mobility of people and businesses results in an increased number of telecommunication received in languages that are not spoken or understood by the receiving party. Generally, when such communication is received, it is largely discarded without being processed. This squanders resources and opportunity. While translation services are available, protocols for connecting parties with translators are often cumbersome and lack automation.

U.S. Patent Application Publication No. 2009/0089042 describes a system and method of selecting a translator and connecting to telecommunication devices. The computer system consists in creating three databases, where the first one connects geographical regions with the languages most commonly used in those regions, the second one comprises a special database of translators of different languages and regions of the world, and the third one—a database of people who want to use a translator to communicate verbally or by means of text messages. The system makes it possible to identify translators and to hold multilateral conference calls using remote audio links.

Accordingly, much opportunity for improvement is found in this area of technology.

### SUMMARY OF DISCLOSURE

Embodiments disclosed herein may provide for a method for providing translation services between a first party speaking a first language and a second party speaking a second language, where the first party and the second party may be physically present in the same general vicinity of each other. The method may include the steps of using a single telecommunication device between the first party and the second party; providing in said telecommunication device an option to select and store an identifier of said first language; receiving and storing in said telecommunication device an identifier of said first language; providing in said telecommunication device an option to select an identifier of said second language; receiving an identifier of said second language via said telecommunication device, wherein said second party may manually select said identifier of said second language; and based on said identifier of said first language and said identifier of said second language, connecting a telecommunication call via said single telecommunication device to a translator that may be able to translate between said first language and said second language.

Other embodiments of the disclosure may provide for a method for providing translation services between a call-placing party speaking a first language and a call-receiving party that may speak a second language, whereby the call-placing party may have a first telecommunication device and the call-receiving party may have a second telecommunication device. The method may include the steps of providing in said first telecommunication device an option to select and store an identifier of said first language; receiving and storing in said first telecommunication device an identifier of said first language; providing in said second telecommunication device an option to select and store an identifier of said second language; receiving and storing in said second telecommunication device an identifier of said second language; transmitting said identifier of said first language and said identifier of said second language to a server, and storing said identifier of said first language and said identifier of said second language in a database operatively associated with the server; receiving a telecommunication call from said call-placing party and receiving from said call-placing party a telephone number of said call-receiving party, other information identifying said call-receiving party, and combinations thereof; and based on said identifier of said first language and said identifier of said second language, connecting a three-way telecommunication call between said call-placing party, said call-receiving party, and a translator able to translate between said first language and said second language.

Yet other embodiments disclosed herein may provide for a system for providing translation services between a first party speaking a first language and a second party speaking a second language. The system may include a first communicator operatively linked with a switchboard, where the first communicator may include a first database of translators and a first language selection option. The system may also include a second communicator operatively linked with the switchboard, where the second communicator may include a second database of translators and a second language selection option.

The system may further include a signal detector operatively associated with the first communicator and the second communicator, whereby the signal detector may be configured to identify the first language and the second language, and may then transmit a signal about selected languages to the switchboard. In addition, there may be an analyzer device operatively connected with the first database and the second database, wherein the analyzer device is configured to analyze and qualify the call.

Other aspects and advantages of the disclosure will be apparent from the following description and the appended claims.

### BRIEF DESCRIPTION OF THE DRAWINGS

FIG. 1 shows a block diagram that illustrates a method for providing translation services between a first party and a second party, in accordance with embodiments of the present disclosure.

FIG. 2 shows a block flow diagram that illustrates method for providing translation services between a call-placing party and a call-receiving party, in accordance with embodiments of the present disclosure.

FIG. 3 shows a block flow diagram that illustrates a system for providing translation services between a call-placing party and a call-receiving party, in accordance with embodiments of the present disclosure.

### DETAILED DESCRIPTION

Specific embodiments of the present disclosure will now be described in detail with reference to the accompanying Figures. Like elements in the various figures may be denoted by like reference numerals for consistency. Further, in the following detailed description of embodiments of the present disclosure, numerous specific details are set forth in order to provide a more thorough understanding of the disclosure. However, it will be apparent to one of ordinary skill in the art that the embodiments disclosed herein may be practiced without these specific details. In other instances, well-known features have not been described in detail to avoid unnecessarily complicating the description.

In addition, directional terms, such as “above,” “below,” “upper,” “lower,” “front,” “back,” etc., are generally used for convenience in referring to the accompanying drawings, but are meant for illustrative purposes only, and the terms are not meant to limit the disclosure.

### DEFINITIONS

The term “translation,” as used herein, refers to, for example, a communication is a second language having the same or a similar meaning as the communication in a first language. The term “translation,” as used herein, includes the normal meaning of this word as it is commonly understood by those skilled in the art.

The terms “translation services,” and “translating” as used herein, refer to, for example, providing translation for others as an occupation or business. These terms are meant to include interpreting, localizing, etc. The terms “translation services,” and “translating” as used herein, include the normal meaning of these words as it is commonly understood by those skilled in the art.

The term “party,” as used herein, refers to, for example, a person or a group of persons. A party may be a private party or a business party; that is to say that a party may be engaging in telecommunication with other parties for private purpose or for a business purpose, respectively.

The term “call-placing party,” as used herein refers to, for example, a party who originally initiates a telecommunication call to a call-receiving party. The term “call-receiving party,” as used herein refers to a party who originally receives a telecommunication call from a call-placing party. The term “party,” as used herein, includes the normal meaning of this word as it is commonly understood by those skilled in the art.

The term “language selection options,” as used herein, refers to, for example, choices given to a party (a call-placing party, a call-receiving party, or any other party) to select one or more languages in which the party can communicate. For example, a call-placing party or a call-receiving party can select English, or German, or English and German as its language selection.

The term “identifier,” as used herein, refers to, for example, a symbol, a name, or any other means of identifying. Particularly, with respect to a language, an identifier may be the name of the language, e.g., the word “English” or “German”, or an abbreviation such as EN, DE, etc. Thus, providing in a telecommunication device option to select and store an identifier of said first language, refers to providing an option to a user of the telecommunication device to pre-set a preferred language in the memory of the telecommunication device, which language the user can communicate in. As such, the user may select and store the word “English” to identify that the user can communicate in the English language.

The term “language selection,” as used herein, refers to, for example, the choice made by a party (a call-placing party, a call-receiving party, or any other party) as to one or more languages in which the party can communicate. For example, a call-placing party or a call-receiving party can select English, or German, or English and German as its language selection.

The term “translator,” as used herein refers to, for example, a person who provides translation from one language to another. The translator may translate messages from one language into another in a spoken form (“interpreter”) or in a written form, or in a combination thereof. All modes of translation are encompasses within the term “translator”. A bilingual translator is a person who is able to communicate in at least two languages fluently. The term encompasses those translators who have membership in two different cultures. The term “translator,” as used herein, includes the normal meaning of this word as it is commonly understood by those skilled in the art.

The term “translation agency,” as used herein refers to, for example, a translator or a group of translators organized for providing translation services by means of telecommunication. The term “translation agency,” as used herein, includes the normal meaning of this word as it is commonly understood by those skilled in the art.

The term “connecting according to the language selection,” as used herein refers to, for example, routing the telecommunication call to a translator proficient and able to translate between at least one language selected by a call-placing party and at least one language selected by a call-receiving party. Thus, for example, if the call-placing party selects German as the language in which it can communicate and the call-receiving party selects French as the language in which it can communicated, “connecting according to the language selection” means that the parties would be connected to a translator that can translate from German into French and vice versa. As another example, if the call-placing party selects German and Spanish as the languages in which it can communicate and the call-receiving party selects French and Russian as the languages in which it can communicated, “connecting according to the language selection” means that the parties would be connected to a translator that can translate from German into French and vice versa, or from German into Russian and vice versa, or from Spanish into French and vice versa, or from Spanish into Russian, and vice versa.

The term “client,” as used herein refers to, for example, a party for which professional services are rendered, a customer or patron. The term “customer,” as used herein refers to, for example, one that buys goods or services. The terms “client,” and “customer” as used herein, include the normal meaning of these words as it is commonly understood by those skilled in the art.

The term “merchant,” as used herein refers to, for example, a person or a group of people who run a business, whether or not for profit, and is meant to encompass those persons whose occupation is the purchase and/or sale of goods and/or services for profit. The term “merchant,” as used herein, includes the normal meaning of this word as it is commonly understood by those skilled in the art.

The term “telephone keypad,” as used herein, refers to, for example, a keypad that appears on a “touch tone” telephone. It was standardized when the dual-tone multi-frequency (DTMF) system was introduced in the 1960s. The contemporary keypad is laid out in a 3×4 grid of “telephone keys”. When used to dial a telephone number, pressing a single key will produce a pitch consisting of two simultaneous pure tone sinusoidal frequencies. The row in which the key appears determines the low frequency, and the column determines the high frequency. For example, pressing the ‘1’ key will result in a sound composed of both a 697 and a 1209 hertz (Hz) tone. The term “telecommunication device keypad,” as used herein, refers to, for example, a keypad that appears on a telecommunication device. A telecommunication device keypad can be physical or virtual, i.e., it can be made of physical buttons or of buttons that appear on the screen (e.g., a touch screen) of a telecommunication device. A telecommunication device keypad in general includes a telephone keypad.

The term “associating each language with one or more telecommunication device keys,” as used herein refers to, for example, providing a party (e.g., a call-placing party, a call-receiving party, or any other party) a way to select one or more languages in which the party can communicate by pressing one or more telephone keys. For example, in order to select English, the party is asked to press the #4 key, or the #4 key followed by the #6 key. A party may also be asked to spell the name of the language to be selected using the key pad. A specified letter mapping standard may be used to map letters to telephone keys. For example, the international standard ITU E.161/ISO 9995-8 is chosen.

The term “preprogrammed,” as used herein refers to, for example, programming in advance, e.g., of the actual call. For example, payment information may be in advance programmed into the system (on the side of the call-placing party, on the side of the call-receiving party, or both, and/or on the side of the translation agency) so that it may be automatically transmitted to pay for translation services when translation services are requested. Preprogrammed payment information may include, by way of example, customer number and pin code, credit card information, etc.

The term “telecommunication,” as used herein, refers to, for example, the science and technology of communication at a distance by electric or electronic transmission of impulses, such as by telegraph, cable, telephone, mobile telephone, walkie-talkie, radio, television, and the like. The term “telecommunication,” as used herein, includes the normal meaning of this word as it is commonly understood by those skilled in the art.

The term “telecommunication call,” as used herein, refers to, for example, a communication or connection between two or more parties at a distance by electric or electronic transmission of impulses, such as by telegraph, cable, telephone, mobile telephone, walkie-talkie, radio, television, etc.

The term “telecommunication device,” as used herein, refers to, for example, anything man-made for communication at a distance by electric or electronic transmission of impulses, such as by telegraph, cable, telephone, mobile telephone, walkie-talkie, radio, television, etc. A telecommunication device includes, but is not limited to, a mobile phone, a personal digital assistant (PDA), a smartphone, and the like.

The term “software and/or hardware means for providing a plurality of language selection options in the telecommunication device,” as used herein, refers to, for example, a device, or anything else man-made, for providing choices to a party (e.g., a call-placing party, a call-receiving party, or any other party) to select one or more languages in which the party can communicate. Means for providing a plurality of language selection options is, for example, a voice announcement, pre-recorded or otherwise, played to the party via a telecommunication device, including a telephone, or a text message, or a pictorial message displayed to the party via, for example, a telecommunication device, such as a mobile phone.

The term “software and/or hardware means for receiving a language selection via the telecommunication device,” as used herein, refers to, for example, a device, or anything else man-made, for receiving the choice made by a party (a call-placing and/or a call-receiving party) as to one or more languages in which the party can communicate. Devices usable for receiving a language selection include, for example, a converter of dual-tone multi frequency signal to a digital number.

The term “software and/or hardware means for connecting a telecommunication call via the telecommunication device to a translator based on the language selection,” as used herein, refers to, for example, a device, or anything else man-made, for teleconferencing a call-placing party, a call-receiving party, and a translator. Means for connecting with a translator is, for example, a telephone exchange programmed to teleconference teleconferencing a call-placing party, a call-receiving party, and a translator based on the language selection.

The term “programmable with information,” as used herein refers to, for example, the ability to input into the memory of the device a list of languages spoken by a party using the device. For example, a call-placing party programs its mobile phone by inputting the languages English, German, and Russian, as the languages spoken by the call-placing party.

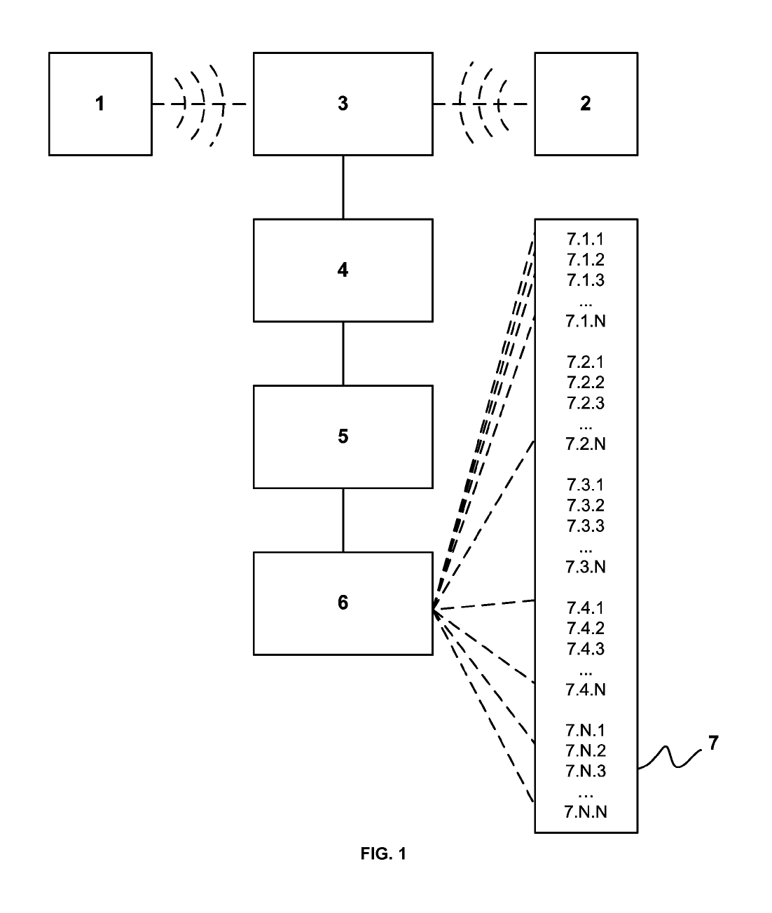

With reference to FIG. 1, a block diagram illustrating a method for providing translation services between a first party 1 and a second party 2, using a telecommunication device 3 according to embodiments of the present disclosure, is shown. When two (or more) parties come together and wish to communicate with one another yet do not speak a common language, it is often desirable to employ a translator 7 able to translate between the parties. The translator 7 may be, for example, a person able to speak and translate between a first language spoken by the first party and a second language spoken by the second party. Frequently, a need for a quick access to a translator arises when the first party travels to a foreign country and cannot communicate in a language spoken in that country. Embodiments disclosed herein may beneficially make it possible to quickly and efficiently provide translation services to the first party.

A first party, in order to obtain translation services, may dial a generally available special telephone number 4 using the telecommunication device. In an embodiment, the first party may be the party who owns the telecommunication device 3. The special telephone number 4 may be provided in a form similar to those of emergency responders (e.g., 911), or may be a regular telephone number, or a prefix. After the call is connected, the party may be given choices by the language selection module 5 to select a language spoken by the first party.

It may be the case that the first party is a party traveling to an area where a language other than that the first party speaks is widely spoken, and that the second party may speak a language common to the area where the parties are present and/or where the special telephone number 4 is provided. This is to say that the special telephone number 4 may be provided for parties who speak a certain language and that the language selection module 5 provides language selection in multiple languages. For example, when the language service is offered in the United States, the second party may speak English and that the first party may speak a language other than English. (But this could be set differently by convention.) Thus, when the special telephone number 4 offered in a foreign country is dialed by the first party, the first party 1 may be asked in a variety of languages to select a language that the first party 1 speaks.

However, if the first party is present in an area where the special telephone number 4 is not available or if the second party does not speak a language common to the area, the first party can place a telecommunication call to the party's own home area to call a special telephone number 4, i.e., a special telephone number 4 that features a language selection module 5 operating in a language spoken by the call-placing party, and transfer the telecommunication device 3 to the second party, who then choose his or her language by using the language selection module.

The language selection module 5 provides the language selection options either as a spoken announcement, (e.g., “For English, press one; Para Espanol, Oprima Numero Dos, fur Deutsch, bitte drücken Sie die drei,” etc.), by entering a combination of telephone keys known from TV commercials, brochures, etc., or as a list of languages that is displayed on the screen of the telecommunication device (touch screen selection). In the latter case, the list of languages can be displayed in stages. For example, the first screen may show a map of the world with contours of continents. Pressing on one of the continents, would open a second screen that would display all individual countries of that continent. Pressing on one of the countries would automatically select a language spoken in that country for single-language countries or open a third screen with selections of languages commonly spoken in that country.

The language selection options are automatically provided and constitute a collection of messages in various foreign languages communicating that one can connect to a given translator for a given price when selecting a specified combination of keys.

All selections may be entered manually using telecommunication device keys or may be made automatically by the translation module (hardware or software based) built into the stationary or mobile phone of the party making the selections. When telecommunication device keys are being used (tone dial selection), it should be assured that selections are entered using the same international standard. For example, the most widely used standard for letter mapping is international standard ITU E.161/ISO 9995-8, wherein A, B, and C are assigned to the number 2 key; D, E, and F are assigned to the number 3 key; G, H, and I are assigned to the number 4 key, and so on.

Once a language selection is received, an automatic exchange 6, which may be a telecommunication device enabling forwarding of telecommunication calls, forwards the call to a first available translator 7. N. N of the language selected using the language selection module 5. Specifically, when the special telephone number is established in an English speaking area, a plurality of translators may be employed by a translation company 7 who are able to translate, e.g., from English to Spanish 7.1.1, 7.1.2, 7.1.3, . . . , 7.1.N, from English to Russian 7.2.1, 7.2.2, 7.2.3, . . . , 7.2.N, from English to German 7.3.1, 7.3.2, 7.3.3, . . . , 7.3.N, from English to Polish 7.4.1, 7.4.2, 7.4.3, . . . , 7.4.N, and from English to other language 7.N.1, 7.N.2, 7.N.3 7.N.N.

Other embodiments disclosed herein may provide for a method for providing translation services between a first party, who uses a telecommunication device, and a second party. Particularly, this method may take advantage of the fact that telecommunication devices usually allow a user to set a language in which information is displayed on the telecommunication device. This language may generally be a language that the party using the telecommunication device can communicate in. For example, a party residing in the United States and able to communicate in English may select “English” as the language of choice in which information is displayed on the telecommunication device of that party, e.g., a mobile phone. This pre-selected language identifier becomes critical at the time language translation is desired.

When the first party comes in contact with a second party who cannot speak the same language as the first party, in order to obtain translation services, the first party dials using the telecommunication device 3 a generally available special telephone number 4. This special telephone number may be provided in a form similar to those of emergency responders (911), or may be a regular telephone number, or a prefix. After the call is connected, the first party may hand the phone to the second party who may then be given choices by the language selection module 5 to select a language spoken by the second party. The preselected language identifier of the language spoken by the first party may then also be automatically transmitted to the translation company and, on the basis of the preselected language and the language selected by the second party, the call may then be connected to a translator that can translate between the two languages.

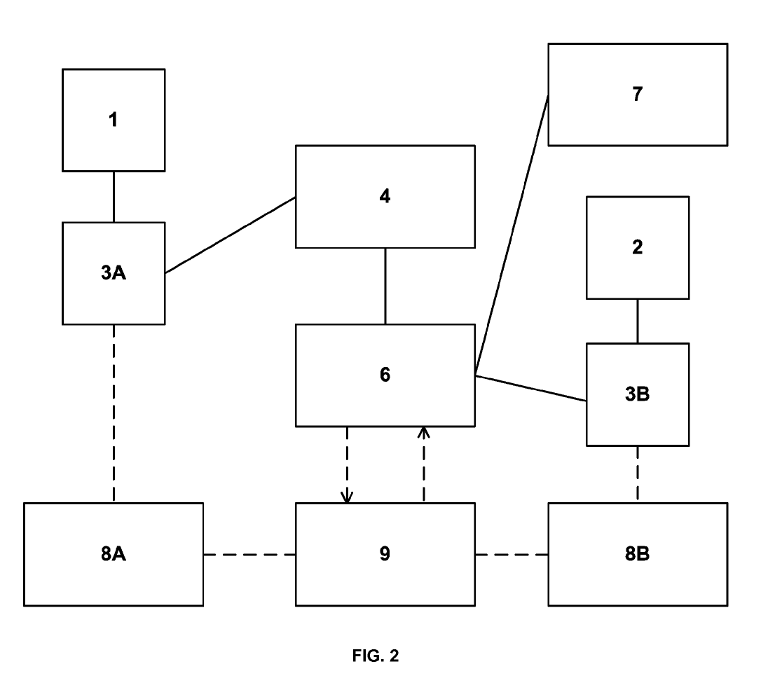

Referring now to FIG. 2, a block diagram illustrating method for providing translation services between a call-placing party 1 and a call-receiving party 2 when each of the parties has its own telecommunication device according to embodiments of the present disclosure, is shown. Thus, FIG. 2 may illustrate when the call-placing party 1 uses a telecommunication device 3A to communicate, and the call-receiving party uses a telecommunication device 3B to communicate.

The call-placing party may preprogram the telecommunication device 3A with a first language selection that the call-placing party may be able to communicate in. The first language selection may be a selection of a language spoken by the call-placing party and used by the call-placing party to operate the telecommunication device. The first language selection may be stored in the first telecommunication device 3A. This is to say that the language selection may be set in the menu of the telecommunication device 3A to operate the device regardless of whether or not the call-placing party will ever use the translation system. During the first connection after the telecommunication device has been put into operation or the language selection has been changed, the telecommunication device 3A may send an information signal with the first language selection to a global computer 9 via telecommunication network operator 8A. The first language selection may then be stored in a global database in association with an identifier for the call-placing party 1. The first language selection can also be additionally stored in a separate database of the telecommunication network operator 8A. This step may occur regardless of whether or not the call-placing party will ever use the translation system.

Similarly, the call-receiving party preprograms the telecommunication device 3B with a second language selection that the call-receiving party is able to communicate in. The second language selection may be a selection of a language spoken by the call-receiving party and used by the call-receiving party to operate the telecommunication device. The second language selection may be stored in the second telecommunication device 3B. This is to say that the language selection is set in the menu of the telecommunication device 3B to operate the device regardless of whether or not the call-receiving party will ever use the translation system.

During the first connection after the telecommunication device has been put into operation or the language selection has been changed, the telecommunication device 3B may send an information signal with the second language selection to a global computer 9 via telecommunication network operator 8B. The second language selection may then stored in a global database in association with an identifier for the call-receiving party 2. The second language selection can also be additionally stored in a separate database of the telecommunication network operator 8B. This step also occurs regardless of whether or not the call-receiving party will ever use the translation system.

Illustrating further with reference to FIG. 2, when the call-placing party 1 wishes to communicate with the call receiving party 2, yet the parties do not speak a common language, it may be desirable to employ a translator 7 able to translate between the two parties, i.e., a translator able to speak and translate between a first language spoken by the call-placing party and a second language spoken by the call-receiving party. Embodiments disclosed herein may beneficially make it possible to quickly and efficiently provide translation services to the parties.

In order to obtain translation services, the call-placing party may dial using the telecommunication device 3A a generally available special telephone number 4 (“GSTPC number”). This special telephone number may be provided in a form similar to those of emergency responders (911), or may be a regular telephone number. After the call is connected, the call-placing party may enter a phone number of the call-receiving party or otherwise identifies the identity of the call-receiving party. Alternatively, the call-placing party may dial the special telephone number 4 and the phone number of the call-receiving party simultaneously. Particularly, the call-placing party may dial a prefix associated with the translation service (a so called “GSTPC prefix”) and the phone number of the call-receiving party in one string before pressing the “SEND” button.

When the call is received the automatic telephone exchange 6 may automatically identify the number of the call-placing party 1. Using the identity of the call-placing party and the identity of the call receiving party, the automatic exchange 6 may look up in (i.e., interface) the global database a language pair spoken by the call-placing party and the call-receiving party, and connect a three-way call between the call-placing party, the call-receiving party, and a first available translator 7. N. N able to translate between the first language spoken by the call-placing party and the second language spoken by the call-receiving party. In particular, the automatic exchange 6 may access the global database residing on a global computer 9 and may retrieve the language selection options of the call-placing party and the call-receiving party that the parties have deposited earlier into the database. In an embodiment, not all translators need to speak the same local language. As such, each translator may be able to translate in a certain language pair (e.g., from Chinese to Japanese, from Czech to French, from Bantu to Mongolian, etc.).

When a call-placing party places a call to a call-receiving party that is not able to communicate in the same language, it may be useful to automatically connect the call to a translator that can translate the communication between the two parties. In order for the call to be automatically connected to a translator, the method may take advantage of the fact that telecommunication devices usually allow a user to set a language in which information is displayed on the telecommunication device. This language may generally be language that the party using the telecommunication device can communicate in. For example, a first party residing in the United States and able to communicate in English may select “English” as the language of choice in which information is displayed on the telecommunication device of that party, e.g., a mobile phone, and a second party residing in Poland and able to communicate in Polish may select “Polish” as the language of choice in which information is displayed on the telecommunication device of that party, e.g., a mobile phone.

The pre-selected language identifier selected by each party may become critical at the time language translation is desired. Specifically, when a call-placing party dials a phone number of the call-receiving party, the system may automatically compare the language identifiers selected and stored by each party in their respective telecommunication devices. When the language identifiers are not equal, e.g., the language identifier pre-selected by the call-placing party is “Polish” and the language identifier pre-selected by the call-receiving party is “English”, the telecommunication device of the call placing party, or the telecommunication device of the call-receiving party, may automatically place a call to a translator that can translate between the two languages identified by the two language identifiers, e.g., a translator that can translate between Polish and English. In other words, the telephone call may thus placed to an appropriate translator automatically based on the language identifiers pre-selected by the two parties.

Of course, the prefix or phone number to be dialed for each language translator may need to be stored in the telecommunication device, or alternatively, a call could may be placed automatically to a main number of a translation company who would then receive the identifiers from telecommunication devices of both parties and route the call to a desired translator based on these language identifiers and any other necessary data that may also be pre-stored in the telecommunication devices, or pre-stored in a database accessible to the translation company.

Embodiments disclosed herein may be particularly advantageous for counter-terrorism operations. Specifically, the ability to rapidly select or preprogram into telecommunication device information about the languages spoken by the owner of the telecommunication device speeds up response to counter terrorism. For example, when the call-placing party is a person reporting an emergency and the call-receiving party is an emergency responder, information about whether or not translation is needed is immediately disseminated when the call is placed and the call can be quickly routed to appropriate operator, or a translator can teleconferenced in. Since terrorism is a global phenomenon, it is important to enable emergency responders and counter-terrorism personnel with the quickest possibility to understand report received from persons having information useful for capturing terrorists.

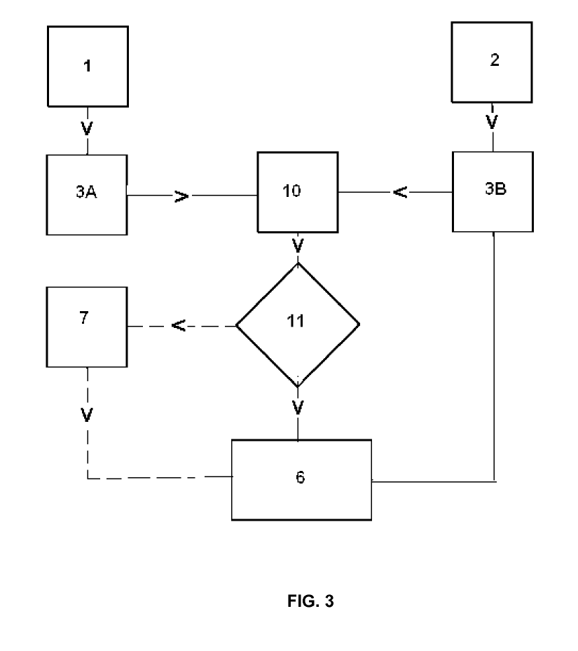

Referring now to FIG. 3, a block diagram illustrating a system useful for providing translation services between a call-placing party 1, and a call-receiving party 2 according to embodiments of the present disclosure, is shown. FIG. 3 illustrates an embodiment where each of the parties may have their own telecommunication device, whereby the call-placing party 1 may use the telecommunication device 3A to communicate and the call-receiving party may use the telecommunication device 3B to communicate. In the system, the communicators 3A and 3B may be equipped with the option of introducing a language code and connected to a switchboard 6 by means of a telecommunication device which identifies the language of the party 10 and a device analyzing and qualifying the call 11 using a database of translators 7 or not.

All publications and patent applications mentioned in this specification are indicative of the level of skill of those skilled in the art to which this disclosure pertains. All publications and patent applications mentioned in this specification are herein incorporated by reference to the same extent as if each individual publication or patent application mentioned in this specification was specifically and individually indicated to be incorporated by reference.

While the present disclosure has been described with respect to a limited number of embodiments, those skilled in the art, having benefit of this disclosure, will appreciate that other embodiments may be devised which do not depart from the scope of the disclosure as described herein. Accordingly, the scope of the disclosure should be limited only by the attached claims.

What is claimed:

1. A method for providing translation services between a first party speaking a first language and a second party speaking a second language, the first party and the second party being physically present in the same general vicinity of each other, the method comprising the steps of:
(a) using a single telecommunication device between the first party and the second party;
(b) providing in said telecommunication device an option to select and store an identifier of said first language;
(c) receiving and storing in said telecommunication device an identifier of said first language;
(d) providing in said telecommunication device an option to select an identifier of said second language;
(e) receiving an identifier of said second language via said telecommunication device, wherein said second party manually selects said identifier of said second language; and
(f) based on said identifier of said first language and said identifier of said second language, connecting a telecommunication call via said single telecommunication device to a translator able to translate between said first language and said second language.

2. The method of claim 1, wherein step (d) comprises providing spoken instructions associating said identifier of said second language with one or more telecommunication device keys.

3. The method of claim 1, wherein step (d) comprises displaying said identifier of said second language on a screen of said telecommunication device.

4. The method of claim 3 wherein said identifier of said second language is displayed in at least one of a plurality of languages, said first language, and combinations thereof.

5. The method of claim 4, wherein step (e) comprises pressing at least one of a portion of the screen, a picture on the screen, a sign on the screen, and combinations thereof that correspond to said identifier of said second language.

6. The method of claim 2, wherein step (e) comprises pressing a telecommunication device key.

7. The method of claim 6, wherein said first party comprises a person reporting an emergency, information about terrorist activities, and combinations thereof, and wherein said second party comprises at least one of an emergency responder, a member of a counter-terrorist organization, and combinations thereof.

8. A method for providing translation services between a call-placing party speaking a first language and a call-receiving party speaking a second language, said call-placing party having a first telecommunication device and said call-receiving party having a second telecommunication device, the method comprising the steps of:
(a) providing in said first telecommunication device an option to select and store an identifier of said first language;
(b) receiving and storing in said first telecommunication device an identifier of said first language;
(c) providing in said second telecommunication device an option to select and store an identifier of said second language;
(d) receiving and storing in said second telecommunication device an identifier of said second language;
(e) transmitting said identifier of said first language and said identifier of said second language to a server, and storing said identifier of said first language and said identifier of said second language in a database operatively associated with the server;
(f) receiving a telecommunication call from said call-placing party and receiving from said call-placing party a telephone number of said call-receiving party, other information identifying said call-receiving party, and combinations thereof; and
(g) based on said identifier of said first language and said identifier of said second language, connecting a three-way telecommunication call between said call-placing party, said call-receiving party, and a translator able to translate between said first language and said second language.

9. The method of claim 8, wherein in step (g) said telecommunication call is routed to said call-receiving party after first being connected to said translator.

10. The method of claim 9, wherein step (a) comprises displaying a plurality of language identifiers on a screen of said first telecommunication device in said first language; and step (c) comprises displaying a plurality of language identifiers on a screen of said second telecommunication device in said second language.

11. The method of claim 10, wherein step (b) and step (d) each comprise pressing at least one of a portion of the screen, a picture on the screen, a sign on the screen, and combinations thereof, which correspond to a language identifier.

12. The method of claim 11, wherein said database comprises a global database.

13. The method of claim 12, wherein said call-placing party comprises a client and said call-receiving party comprises a merchant.

14. The method of claim 12, wherein said call-placing party comprises at least one of a person reporting an emergency, a person reporting information about terrorist activities, and combinations thereof, and wherein said call-receiving party comprises at least one of an emergency responder, a member of a counter-terrorist organization, and combinations thereof.

15. A system for providing translation services between a first party speaking a first language and a second party speaking a second language, the system comprising:
a first communicator operatively linked with a switchboard, the first communicator comprising a first database of translators and a first language selection option;
a second communicator operatively linked with the switchboard, the second communicator comprising a second database of translators and a second language selection option;
a signal detector operatively associated with the first communicator and the second communicator, whereby the signal detector is configured to identify the first language and the second language, and then transmit a signal about selected languages to the switchboard; and
an analyzer device operatively connected with the first database and the second database, wherein the analyzer device is configured to analyze and qualify the call.

16. The system of claim 15, wherein each of the first communicator and the second communicator each comprise a processor configured with programmed instructions to provide each of the communicators with a plurality of language selection options.

17. The system of claim 15, wherein the signal detector is configured with a detector processor programmed to receive and process information about any of the languages selected during the call.

18. The system of claim 15, wherein the analyzer device comprises a programmable analyzer processor.

19. The system of claim 15, wherein the switchboard comprises a switchboard signal detector configured to identify the language of any party; and a switchboard analyzer device configured to analyze and qualify the call.
